(19) United States
(12) Patent Application Publication
(10) Pub. No.: US 2017/0047663 A1
(43) Pub. Date: Feb. 16, 2017

(54) CONTROL OF RF REFLECTIVITY FOR RADAR CAMOUFLAGE

(71) Applicant: George Martin Hall, Sebastian, FL (US)

(72) Inventor: George Martin Hall, Sebastian, FL (US)

(21) Appl. No.: 15/236,423

(22) Filed: Aug. 13, 2016

Related U.S. Application Data
(60) Provisional application No. 62/205,437, filed on Aug. 14, 2015.

(51) Int. Cl. H01Q 15/14; G01S 7/38

(52) U.S. Cl. CPC H01Q 15/148; G01S 7/38

(57) ABSTRACT

Methods, systems, and apparatus for real-time control of radio frequency (RF) reflectivity to enable radar camouflage are disclosed. A spatially diverse collection of elements, consisting of at least two elements, are used to control the direction of reradiated (reflected) energy from an object or person where direction of the reradiated energy is controlled by a circuit and a controller. The controller and circuit changes the reflectivity of each element individually as a function of time. The effect of the spatial distribution and time varying reflectors is a reflected RF signal that can statistically mimic background clutter.

### CROSS-REFERENCE TO RELATED APPLICATION

This application claims the benefit of U.S. Provisional Application No. 62/205,437, filed Aug. 14, 2015, which is incorporated herein by reference.

### FIELD OF THE INVENTION

The invention generally relates to RF camouflage. More particularly, the invention relates to camouflage through the use of cantollable RF reflective surfaces

### BACKGROUND OF THE INVENTION

Radar is an effective means for detection and tracking of objects in a wide variety of conditions. Radar works by a receiver sensing radio frequency (RF) energy produced by a transmitter reflected from an object of interest. One type of simplistic Radar uses only the time difference between the emission of an illuminating RF source (transmitter) and time that the reflected signal from the object of interest is received at the radar. Another simple radar does not measure range, but instead, using a continuous transmission of RF energy at a fixed frequency, senses the movement of an object by measuring the Doppler shift of the reflected energy. More complex Radar, in an effort to separate objects of interest from other reflectors, use 1) frequency differences between the transmitted RF signal and the received signal, 2) phase differences between multiple reflected pulses, or 3) combinations of these two approaches. In all radar a detector within the receiver then compares the space-time or angle-time characteristics of the received signal and compares it to a model of background reflectors (clutter) and noise. If the reflected signal object of interest is sufficiently different from the expected clutter reflections, then a detection is asserted.

The most common method of defeating this process is to reduce the Radar Cross Section (or effective area that reflects RF energy) of the person, vehicle, or device to be hidden from radar detection. There exist several methods to defeat radar detection: 1) absorption of the RF energy used to illuminate the object—preventing the radar from sensing the object, 2) design surface properties causing reflection of RF energy away from the receiver, 3) physical designs that reduce in energy reflected back to the receiver, or 4) creation of signal to disable or confuse the radar receiver. The first 3 techniques are often referred to collectively as “stealth” and the last technique is often referred to as “jamming”.

Stealth techniques to defeat radar detection such as techniques 1 & 2 can be quite expensive. In addition, the required surface treatments are not suitable for all application. For example, radar absorbing paint is often impregnated with ferromagnetic particles (metal) making it heavy. The capacity to carry the additional weight compromises some designs, such as soldiers' uniforms and lightweight UAVs.

Physical designs that attempt to suppress reflection of energy back towards the receiver are effective when the orientation of the object, transmitter, and receiver are known or can be predicted. For high flying aircraft attempting to evade detection by traditional surface radar this condition may be satisfied. However, in radar design where the transmitter and receiver are not collocated (bistatic radar), the required orientation is harder to model, predict, and achieve. In addition, some radar applications, such as vehicle detection, where the radar and the object orientation vary widely over time, this approach is less effective.

Jamming overwhelms either the radar receiver hardware with too much energy or the detector with additional signals that mask the object in the detector. This approach to defeating radar detection requires the generation of large amounts of RF energy, which is expensive in terms of power.

### BRIEF SUMMARY OF THE INVENTION

The present invention includes a method and apparatus for passively adding modulations to the reflections from a surface, causing a detector that is part of a receiver processor to classify the target as clutter. The present invention is a useful innovation over previously known and practiced methods in that the present invention does not require precise control in the direction of reflections, nor does it require absorption of RF energy, nor the generation of energy.

RF energy, such as from a radar, reflected from spatially separated array of reflectors add coherently. Coherent addition from a spatial array of reflectors means that amplitude and phase of the reflected energy varies as a function of angle as used in the present invention embodiments. In addition, the variation as a function of angle changes if amount of energy from reflected from any of the individual reflectors changes.

Embodiments of the present invention use an array of RF reflectors to create reflections that vary in intensity and/or phase for a large number of directions, potentially all, at the same time. This is accomplished by changing the amplitude or phase of reflected RF energy as a function of time from individual elements that make up an array. This will cause, through coherent addition, the total reflected energy to vary in each individual angular direction.

A purpose of this variation in reflection as a function of time across different angles is to camouflage an object by making the statistical properties of its reflections close to that of clutter. The temporal and spatial patterns of individual reflectors in an array, or the specific lack of patterns, control how much the reflected signal mimics the surrounding clutter. This will cause misclassification in radar detectors leading to non-detection. The pattern of individual reflectors in an array is managed by a Controller that is able to individually control each reflectors reflectance or direction of reflectance. This technique can also be combined with the existing techniques of: absorption, surface designs, material properties designs, or jamming, to further enhance their net effect of camouflaging the object of interest from radar.

The Controller can be a simple device for cycling through a number of predetermined states for each reflector, or a device for generating random states of reflection for individual reflectors in the array, or a device that senses the surrounding environment and determines the most appropriate pattern of reflectances of the individual reflectors in the array required to model the clutter environment.

A benefit of the proposed invention is the low complexity in array design and insensitivity to orientation relative to the transmitter and receiver. RF antennas arrays used for transmission and reception of energy require extremely well controlled element spacing. In addition, steering them to a specific direction requires precision control of phase and amplitude. The array of reflecting elements required to cause RF energy to be reflected into a number of different directions is easy to achieve. This is because the direction that the resulting energy is scattered into is not important as long as it is not directly returned for every used configuration of the individual reflectors. Therefore, the array does not need to be regular in its spacing between elements, the specific pattern is not critical.

A benefit of the proposed invention is its potential low power application. Elements for reflection of RF energy are effectively the same as antennas designed for receiving the same RF energy. The ability of an antenna to reflect RF energy is government by its impedance or ratio of resistance, capacitance and inductance—the three fundamental properties of an electric circuit element. For an antenna these properties can be controlled with simple diode circuits, which require no power only a voltage difference. The required voltage difference could be supplied by a very small battery. The required energy is much lower that the production of RF energy.

A benefit of the proposed invention is its potential for light weight applications. Reflective antennas can be applied to a surface or sewn into a fabric, using very thin and light weight components. This allows for the inclusion of this invention in and on a large number of vehicles and clothing, including very light applications.

### BRIEF DESCRIPTION OF THE SEVERAL VIEWS OF THE DRAWING

The present invention will become more fully understood when considered together with the accompanying drawings which are provided by way of illustration of a particular embodiment and are not to be considered to limit the present invention, and wherein:

FIG. 1 is a diagram illustrative of an operational environment of the present invention with typical radar geometry for dismounted soldier detection;

FIG. 2 is a top view of an apparatus in operation in accordance with at least one embodiment of the invention;

FIG. 3 is a side view of the apparatus also shown in FIG. 2;

FIG. 4 is a schematic of an embodiment of the invention; and

FIG. 5 is a block diagram of the information flow from an environmental sensor to the retroflector in accordance with some embodiments of the invention.

### DETAILED DESCRIPTION OF THE INVENTION

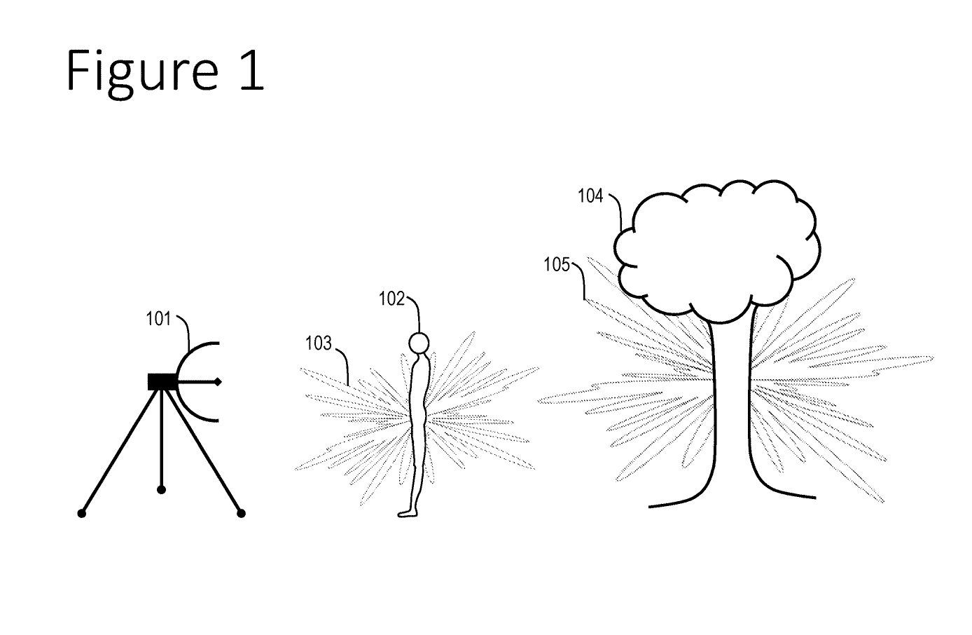

FIG. 1 illustrates a common application for radar and an application for which various embodiments of the invention can be used. In the figure the radar [101] transmits RF energy at the target [102]. The target reflects some of that energy [103] back at the radar with a time delay that is proportional to the distance. If the target is moving, multiple pulses of RF energy with return with slightly different distances. The radar measure the changes in phase from one return to the next. However, the radar also illuminates object that are not the target of interest, in this figure represented as a tree [104]. In the absence of motion of the tree the energy reflected from the tree [105] does not show a phase difference from one return and the next. However, wind and other random effects will cause the tree to sway and the leaves to shake, this will impart a random phase on the energy that is returned. This type of effect is described as clutter. If the target and the clutter are sufficiently different in the statistics of the phase of the returns then the radar can differentiate the target from the clutter. In this environment the invention could be used to sense the motion of the tree, through an acoustic sensor, and cause the reflections of the radar energy [103] off of the person [102] to mimic the reflections [105] off of the tree.

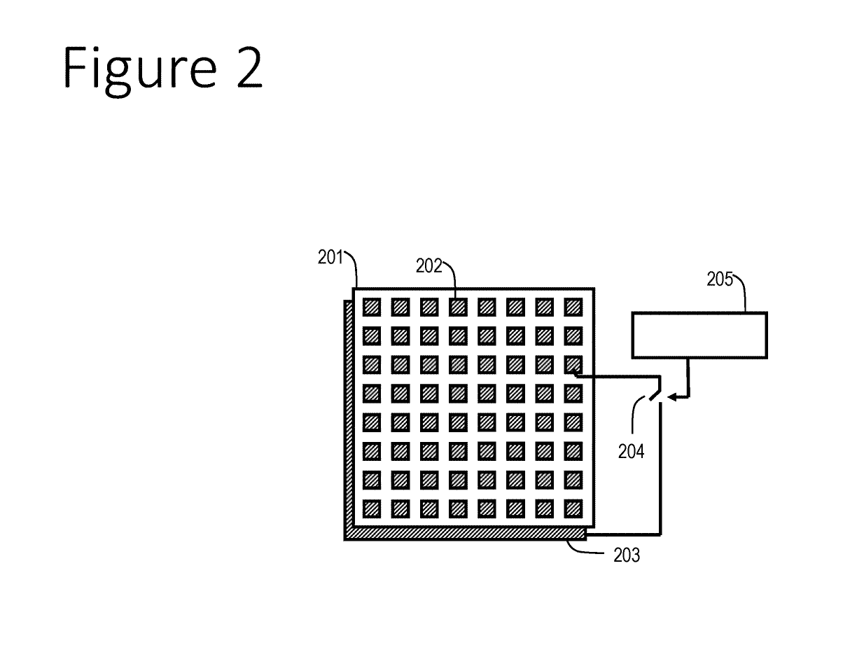

FIG. 2 illustrates an embodiment of the invention. This figure shows a retroreflector consisting an array of metal patch reflectors [202], separated from each other and a metal ground plane [203] by an insulator [201], an array of switches that change the reflectance of the patch reflectors [204] and a controller [205]. The controller individually changes the reflectivity of each reflector such that not all reflectors are reflective at the same level at the same time. In this example, this is accomplished by creating a circuit where each patch reflector [202] can be electrically connected to the ground plane [203]. This creates a surface pattern that causes the RF energy hitting it to be reflected back at an angle that is different from the reflection angle from a surface without the invention would not. In addition, over the course of time changes in the pattern on the surface redirects future reflection in new directions. This causes the radar to observe not a steady reflection of a target but the fluctuating reflection of clutter.

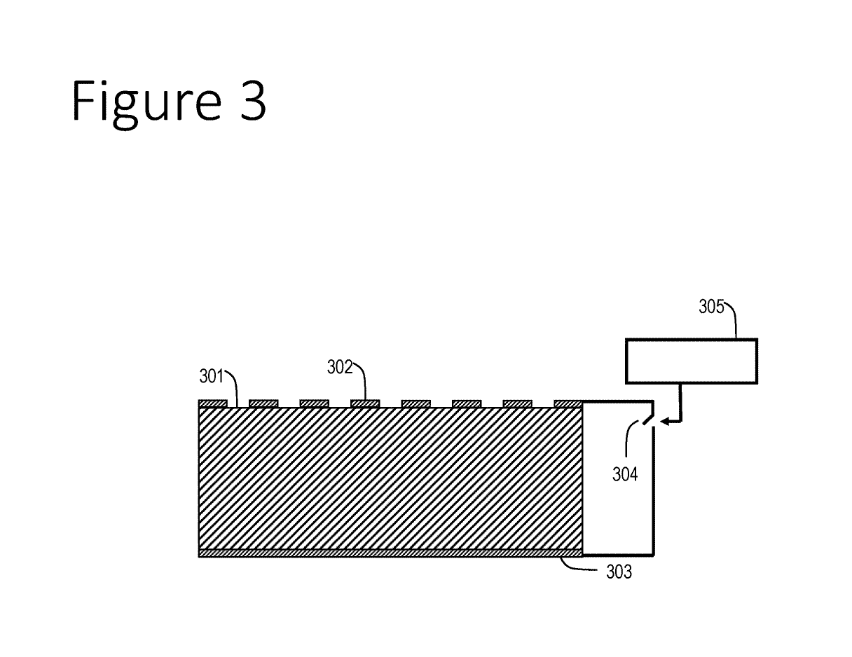

FIG. 3 illustrates the side view of the embodiment shown from above in FIG. 2. This figure shows a retroreflector consisting an array of metal patch reflectors [302], separated from each other and a metal ground plane [303] by an insulator [301], an array of switches that change the reflectance of the patch reflectors [304] and a controller [305]. The controller individually changes the reflectivity of each reflector such that not all reflectors are reflective at the same level at the same time. In this example, this is accomplished by creating a circuit where each patch reflector [302] can be electrically connected to the ground plane [303].

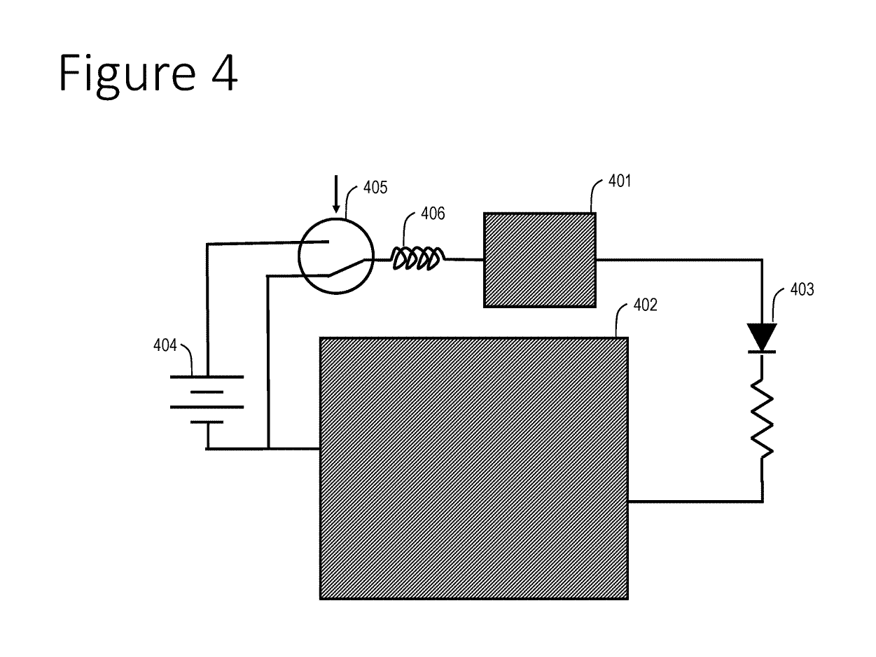

FIG. 4 illustrates an example of one switching circuit for changing the reflectivity of a reflecting patch [401] and ground plane [402] combination. The example as shown in FIG. 4 is not the only circuit, and one of many that would be known to one of ordinary skill in the art, that can be used for this purpose. This figure provides more detail of the array of switches [204]. The patch [401] illustrated here is a single example of the array [202] and the ground plane [402] is the same as [203]. In FIG. 4 the reflective patch is electrical connected in a circuit, to the diode resister pair [403], the battery [404], switch [405] and the inductor [406]. When the controller changes the state of the switch [405] to the circuit path with the battery, the patch [401] voltage increases enabling the diode to become conductive at RF frequencies. When the controller changes the state of the switch [405] to the circuit path without the battery, the patch [401] voltage decreases preventing the diode from passing RF frequencies. These two states have different reflectivities. The inductor [406] prevents RF signal from traveling back through the switch to the ground plane [402].

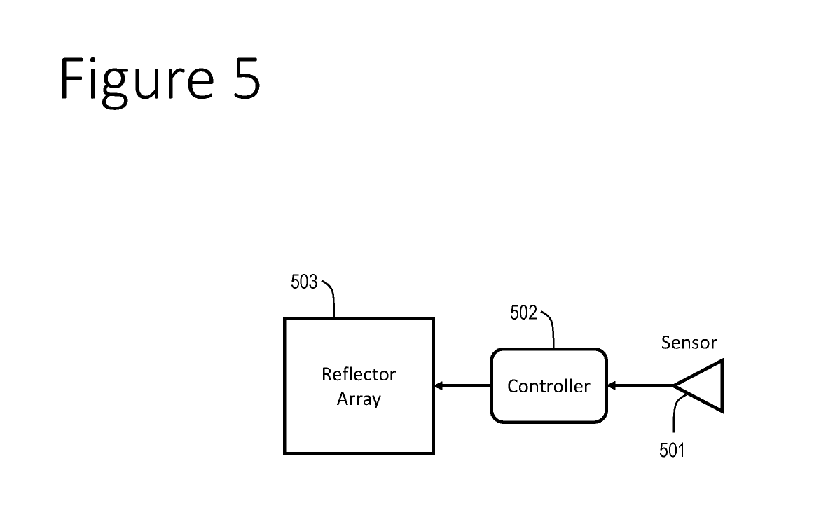

FIG. 5 illustrates how embodiments of the present invention's radar camouflage can adapt to current environmental conditions. An environmental sensor [501] samples the current conditions. In the example shown in FIG. 1, the environmental sensor could be a microphone that detects the amount of wind noise, or a camera that observes the apparent motion in a visual scene, or even an auxiliary RF receiver that measures scatter radiation from the incoming RF energy off of the clutter. This information about the state of the clutter environment is sent to the controller [502]. The controller then creates patterns for the retroreflector [503] that mimic the current clutter environment

In a preferred embodiment, the apparatus is an array of antenna intended to reflect RF energy are sewn into a garment worn by a solider. Each reflector (o antenna) has two possible states: reflective with a 180 degree phase shift applied to the reflected energy and reflective with a 0 degree phase shift applied to the reflected energy. The state of each antenna in this embodiment is controlled by a control voltage applied to a switch from a computer also worn. This switch changes that reflector's reflectivity between states. The computer uses an acoustic sensor to detect noise consistent with leaves rustling. The computer determines how quickly leaves are rustling, for example with a Fourier transform. In the example, high frequency leaf noises would correspond to fast changes in the individual antenna phases. The computer then changes the individual antenna phase shifts, using the attached switches, in an uncoordinated spatial pattern at a temporal rate designed to mimic leaves rustling. RF energy from a radar would be reflected by each individual element in the array with its own phase shift applied. The coherent summation of this phase shifts at the radar receiver would result in an amplitude and phase that fluctuates similar to the reflections from windblown clutter.

There are a number of other possible embodiments.

In another embodiment, a covering shell or cloth has a spatial distribution of flat metal plates that can be mechanically manipulated to change their orientation, changing the direction that each individual plate will reflect RF energy. The mechanical devices that change the plate orientations, such as servos, are controlled by a computer. The computer causes the plates to change orientation in slowly in a spatial pattern that travels along the surface. In this way the spatial and temporal reflective profile of water waves is created.

In another embodiment, a munition is design to have sections of metal casing electrically isolated from one another. A circuit is attached to the casing enabling the sections to be electrically coupled and decoupled, that is an electrical switch. A simple timer causes the sections of the casing to become electrically coupled and decoupled with pseudo-random, emulating a noise like reflector.

In another embodiment, a surface preparation, like paint, is added to a vehicle, where the surface preparation is a set of electrically conductive shapes of many sizes with dimensions that are intended to reflect many wavelengths of radio frequency energy with one phase and amplitude when not electrically connected to the vehicle, but with a different phase and amplitude when electrically connected to the vehicle. The electrical connection to the vehicle of the conductive shapes is controlled by a computer. The specific spatial and temporal pattern of the shorting selected and applied by the computer while monitoring the local motion of clutter objects, such as other vehicles, with a video sensor.

Other possible embodiments are possible and could be accomplished without further technical explanation by a person reasonably skilled in the art. Other such embodiments include but are not limited to 1) a set of individually controlled mechanically manipulated surfaces that enable RF energy to be reflected into various different directions, 2) cases where the controller can be a simple pattern generator or even a collection of random modulations, and 3) other combinations of environmental sensors, controllers, and sensors are possible

The Controller can provide the switching voltage as a digital signal or by amplification of an analog signal directly from an environmental sensor.

In each embodiment, the pattern of reflectivities can be used to directly emulate the specific patterns of a reflection associated with different object. This can be accomplished by pre-recording the reflectivities of the object to be emulated. The Controller would then use this record to generate the correct reflector states.

In each embodiment, the pattern of reflectivities can be used to modulate the incoming RF energy with information for communication or identification. This can be accomplished by the Controller repeating a pre-determined pattern of reflectivities that are not statistically similar to clutter but instead create a temporal pattern of reflections that a compatible receiver can interpret.

One method for creation of a reflector that can be controlled by a voltage and would be used in an array in the present invention is further explained in U.S. Pat. No. 7,383,026 B1, which is herein incorporated by reference in its entirety.

One method for creation of a reflector that can be controlled by a voltage and would be used in an array in the present invention is further explained in U.S. Pat. No. 7,929,195 B2, which is herein incorporated by reference in its entirety.

One method for creation of a surface application that has a spatially varying reflectivity that can be controlled by a voltage that would be used in an array in the present invention is further explained in U.S. Pat. No. 9,105,978 B2, which is herein incorporated by reference in its entirety.

I claim:

1. An apparatus for camouflage comprising at least two spatially separated reflectors and at least one controller, wherein at least one of the reflectors reflectivity can be adjusted by the controller.

2. An apparatus for camouflage as claimed in claim 1, wherein the reflectivity in either amplitude or phase of at least of the reflectors is changed by the application of a voltage from a controller.

3. An apparatus for camouflage as claimed in claim 1 further comprising at least one transducer, wherein the individual reflectors are each retroreflectors, wherein the relative position of the retroreflectors is changed by a transducer controlled by a controller.

4. An apparatus for camouflage as claimed in claim 1 further comprising at least one sensor to measure the current state of the environment.

5. An apparatus for camouflage as claimed in claim 4, wherein the at least one sensor includes at least one acoustic sensor.

6. An apparatus for camouflage as claimed in claim 4, wherein the at least one sensor includes at least one electro-optic sensor.

7. An apparatus for camouflage as claimed in claim 4, wherein the at least one sensor includes at least one radio frequency sensor.

8. An apparatus for camouflage as claimed in claim 1, wherein the reflectivity in either amplitude or phase of at least of the reflectors is changed by the application of a voltage from a controller, wherein the at least two spatially separated reflectors are part of an article of clothing.

9. An apparatus as claimed in claim 8, further comprising at least one sensor to measure the current state of the environment.

10. An apparatus for camouflage as claimed in claim 1, wherein the at least one of the reflectors is a structural element of a mechanical device, and wherein the reflectivity in either amplitude or phase of at least of the reflectors is changed by the application of a voltage from a controller.

11. An apparatus for camouflage comprising at least two spatially separated reflectors and at least one controller, wherein the reflectivity of at least one reflector can be adjusted by at least one of the controllers, said at least one of the controllers using a pre-determined spatio-temporal pattern of signal to control at least one reflector.

12. A system comprising:
a. an apparatus comprising at least two spatially separated reflectors and at least one controller, wherein each reflector has a reflectivity, wherein each reflector receives RF energy at a first amplitude and a first phase, wherein each reflector reflects RF energy at a second amplitude and a second phase in a manner consistent with said reflector's reflectivity, and wherein the reflectivity of at least one reflector can be adjusted by at least one of the controllers, and
b. a radio frequency receiver.

13. A system as claimed in claim 12, wherein the radio frequency receiver interprets the reflected energy at the various second amplitudes and second phases from each of the spatially separated reflectors, and wherein the receiver interprets such second amplitudes and second phases as a specific pattern of reflectivies and wherein said specific pattern of reflectivities is used by the receiver to identify the apparatus.

14. A system as claimed in claim 12, wherein the radio frequency receiver interprets the reflected energy at the various second amplitudes and second phases from each of the spatially separated reflectors, and wherein the receiver interprets such second amplitudes and second phases as a specific pattern of reflectivies and wherein said specific pattern of reflectivities is used by the receiver to encode information.

15. A system as claimed in claim 12, wherein the radio frequency receiver interprets the reflected energy at the various second amplitudes and second phases from each of the spatially separated reflectors, and wherein the receiver interprets such second amplitudes and second phases as a specific pattern of reflectivies and wherein said specific pattern of reflectivities emulates the reflectivity of another specific object.

16. A system as claimed in claim 12, wherein the reflectivity in either amplitude or phase of at least of the reflectors is changed by the application of a voltage from a controller.

17. A system as claimed in claim 12, said apparatus further comprising at least one transducer, wherein the individual reflectors are each retroreflectors, wherein the relative position of the retroreflectors is changed by the transducer controlled by a controller.

18. A method of emulating clutter, comprising:
a. Measuring environmental fluctuations with a transducer;
b. Determining the frequency of environmental fluctuations with a controller,
c. Creating a spatio-temporal pattern with said controller of switch configurations to emulate a statistically similar environmental fluctuation.
